(19) United States
(12) Patent Application Publication
(10) Pub. No.: US 2004/0109119 A1
(43) Pub. Date: Jun. 10, 2004

(54) In-plane switching liquid crystal display with high aperture ratio

(75) Inventor: Deuk Su Lee, Taoyuan Hsien (TW)

Correspondence Address: SENNIGER POWERS LEAVITT AND ROEDEL, ONE METROPOLITAN SQUARE, 16TH FLOOR, ST LOUIS, MO, 63102, US

(73) Assignee: HannStar Display Corporation

(21) Appl. No.: 10/310,216

(22) Filed: Dec. 5, 2002

(51) Int. Cl. G02F 1/1343

(52) U.S. Cl. 349/141

(57) ABSTRACT

The present invention discloses an in-plane switching (IPS) LCD having a plurality of pixels arranged in a matrix to be formed on a transparent insulating substrate. A region, bounded by a pair of gate bus lines and a pair of signal bus lines, defines a unit pixel region. Each common electrode overlaps with one of the signal bus lines in parallel. A gate electrode extended from an adjacent gate bus line goes toward the gate bus line of the pixel. A switching element formed in the pixel is a three-terminal thin film transistor whose one terminal is connected to a pixel electrode by passing through the middle of the pixel, and the other two terminals are respectively connected to the gate bus line and the signal bus line. The pixel electrode overlaps with the gate electrode in parallel, and the storage capacitor of the pixel is formed therebetween.

### BACKGROUND OF THE INVENTION

1. Field of the invention

The present invention relates to a liquid crystal display (LCD), and more particularly, to an in-plane switching (IPS) LCD having a high aperture ratio.

2. Description of the Related Art

Liquid crystal displays (LCD) are replacing other display devices, such as CRTs, and become the most outstanding flat panel displays. In view of the driving methods of the LCDs, which can be classified into a simple matrix type and an active matrix type.

An active matrix type LCD has a plurality of switching elements having non-linear characteristics, and pixels of the LCDs are controlled by the switching elements. Examples of the switching elements are three-terminal thin film transistors (TFTs) and two-terminal thin film diodes such as metal-insulator-metal (MIM) devices.

A commonly used TFT LCD comprises a substrate having pixel electrodes, an opposite substrate having a common electrode, and a liquid crystal material between these two substrates. When the pixel electrodes and the common electrode are supplied with voltages, the molecules of the liquid crystal material change their orientations in response to the electrical field due to the potential difference between the pixel electrode and the common electrode.

However, the conventional LCD has a narrow viewing angle and a contrast dependent on the viewing angle. Furthermore, there is a problem that the number of the process steps is too many because the electrodes are formed in each substrate and the two substrates have a short point for applying voltages into the common electrode.

In order to overcome these problems, IPS LCDs show the best of the suggested solutions. An IPS LCD has pixel and common electrodes formed in only one of the two substrates, and the voltage difference of the pixel electrodes and the common electrode produces substantially horizontal electric fields. FIGS. 1(a) and 2(a) are both layout diagrams of conventional IPS LCDs. As show in FIG. 1(a) a pixel 10, a common electrode 11 is formed on a glass substrate (not shown) in a transverse direction, and its longitudinal branches 111 and 112 go towards gate bus line 13. A pixel electrode 14 overlaps with the common electrode 11, and its longitudinal branch 141 crossing the middle of the pixel 10 is connected to a thin film transistor 15. A signal line 12 crossing the gate bus line 13 is formed in a longitudinal direction to be connected to the thin film transistor 15.

FIG. 1(b) is a cross-section diagram taken along the line 1-1 in FIG. 1(a). Because of the signal line 12, the longitudinal branches 111 and 112 of the common electrode 11 and the longitudinal branch 141 of the pixel electrode 14 are all arranged in parallel direction without mutually overlapping, and the aperture ratio of the pixel 10 has its limitation on geometric disposition. In addition, two insulating layers including a gate insulating layer 17 and a passive layer 18 are superposed on the glass substrate 16 in sequence.

In comparison with FIG. 1(a), FIG. 2(a) provides an overlapping structure to obtain a higher aperture ratio for enhancing transmittance of incident light from a backlight. That is, a common electrode 21 overlaps with a signal line 22 in a pixel 20, and a pixel electrode 24 overlaps with a gate bus line 23. The longitudinal branch 241 extended from the pixel electrode 24 crosses the middle of the pixel 20 to be connected to a thin film transistor 25. Referring to A1-A4 being the width of the apertures in FIG. 1(b) and FIG. 2(b), the pixel 10 has a higher aperture ratio than the pixel 20 due to A3>A1 and A4>A2, and receives more transparent area for transmitting light. In addition, three insulating layers including a gate-insulating layer 27, a passive layer 28 and a resin insulator 29 are superposed on the glass substrate 26 in sequence.

However, these conventional IPS LCDs have a disadvantage that the gate bus line 23 is too wide to occupy larger area on a pixel, as shown in FIG. 2(c) taken along the line 3-3 in FIG. 2(a). If it is possible to reduce the width of the gate bus line, an IPS LCD can improve transmittance of incident light to a large aperture ratio.

### SUMMARY OF THE INVENTION

The first object of the present invention is to improve the transmittance of light on an IPS LCD by reducing the width of gate bus line to obtain a high aperture ratio.

The second object of the present invention is to provide an IPS LCD with lower power consumption by increasing horizontal electric fields by means of an additional ITO electrode overlaid and contacting the pixel electrode to enhance the storage capacitance.

The third object of the present invention is to have an IPS LCD with high resolution by reducing the width of gate bus line to obtain a smaller pixel region.

In order to achieve these objects, the present invention discloses an in-plane switching (IPS) LCD having a plurality of pixels arranged in a matrix to be formed on a transparent insulating substrate. A region, bound by a pair of gate bus lines and a pair of signal bus lines, defines a unit pixel region. Each common electrode overlaps with one of the signal bus lines in parallel. A gate electrode extended from an adjacent gate bus line goes toward the gate bus line of the pixel. A switching element formed in the pixel is a three-terminal thin film transistor whose one terminal is connected to a pixel electrode by passing through the middle of the pixel, and the other two terminals are respectively connected to the gate bus line and the signal bus line. The pixel electrode overlaps with the gate electrode in parallel, and the storage capacitor of the pixel is formed therebetween.

In the IPS LCD according to the present invention, the gate bus lines and the gate electrodes are formed on the transparent insulating substrate, and a gate-insulating layer is overlaid thereon. The pixel electrodes and the signal lines are separately formed on the gate-insulating layer in perpendicular to the gate bus lines, and a passive layer is overlaid thereon. Each of the common electrodes is formed on the passive layer in parallel to each of the signal lines.

### BRIEF DESCRIPTION OF THE DRAWINGS

The invention will be described according to the appended drawings in which:

FIG. 1(a) shows a prior schematic layout diagram of the IPS LCD;

FIG. 1(b) shows a cross-sectional diagram taken along the line 1-1 of FIG. 1(a);

FIG. 2(a) shows a prior schematic layout diagram of the IPS LCD;

FIG. 2(b) shows a cross-sectional diagram taken along the line 2-2 of FIG. 2(a);

FIG. 2(c) shows another cross-sectional diagram taken along the line 3-3 of FIG. 2(a);

FIG. 3(a) shows a schematic layout diagram of the IPS LCD in accordance with the first embodiment of the present invention;

FIG. 3(b) shows a cross-sectional diagram taken along the line 4-4 of FIG. 3(a);

FIG. 4(a) shows a schematic layout diagram of the IPS LCD in accordance with the second embodiment of the present invention;

FIG. 4(b) shows a cross-sectional diagram taken along the line 5-5 of FIG. 4(a);

FIGS. 5(a)-5(d) show manufacturing steps of the IPS LCD shown in FIG. 3(a); and

FIG. 6 shows a manufacturing step of the IPS LCD shown in FIG. 4(a).

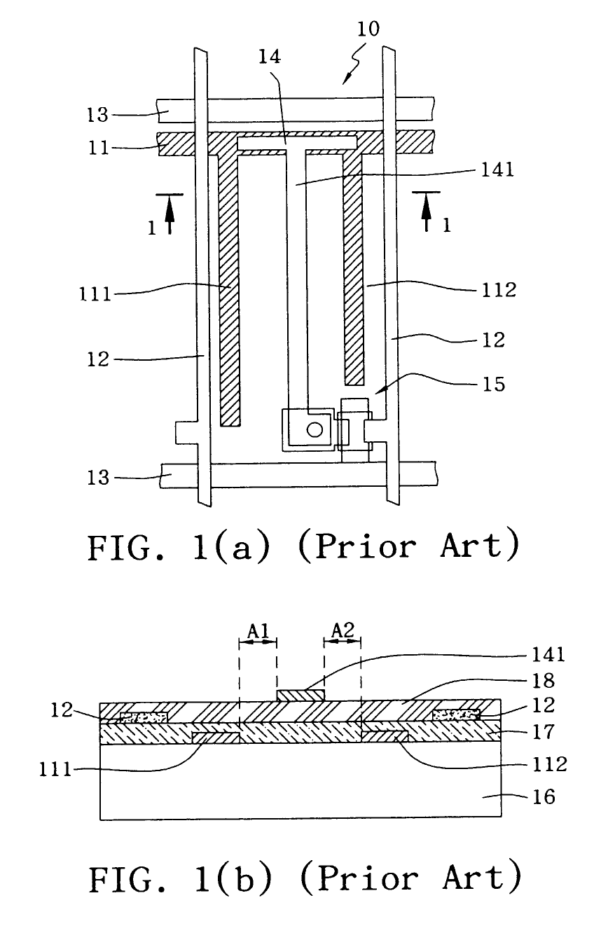

### PREFERRED EMBODIMENT OF THE PRESENT INVENTION

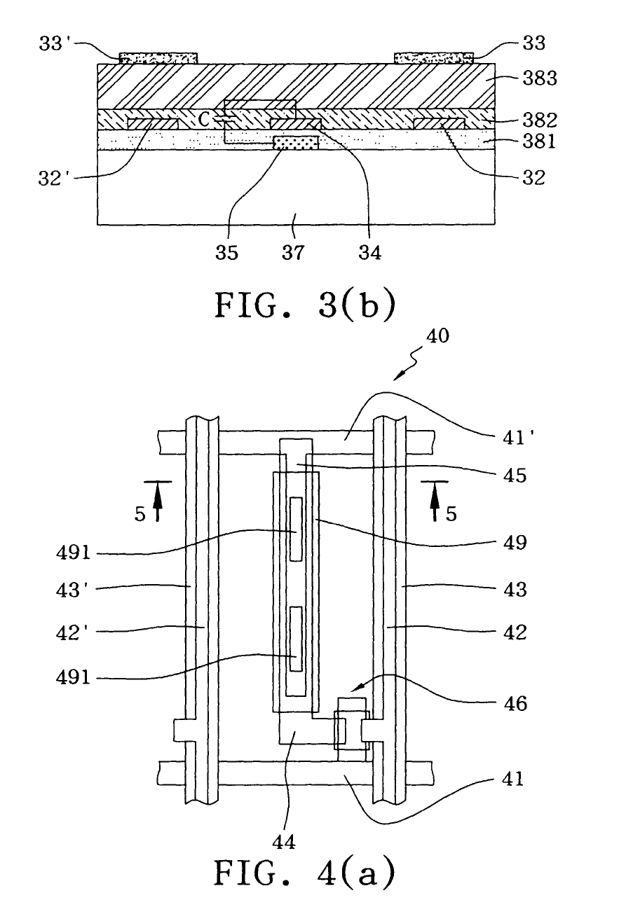

Referring to FIG. 3(a), the pixel 30 of the IPS LCD, in accordance with the first embodiment of the present invention, is shown. A pair of gate bus lines 31 and 31′ is formed on a transparent insulating substrate such as a glass substrate in a transverse direction, and the gate electrode 35 extended from the gate bus lines 31′ of the adjacent pixel goes towards the gate bus lines 31. A pixel electrode 34 completely overlaps with the gate electrode 35 from the middle of the gate bus lines 31′ to the position close to gate bus lines 31, and is wider than the gate electrode 35. The signal bus lines 32 and 32′ separately cross the gate bus lines 31 and 31′ on two longitudinal sides of the pixel 30 in transverse direction. A switching element 36 formed in the pixel 30 is a three-terminal thin film transistor whose one terminal is connected to the pixel electrode 34 and the other two terminals are separately connected to the gate bus line 31 and the signal bus line 32. One common electrode 33 overlaps with the signal bus line 32, and another common electrode 33′ overlaps with the signal bus line 32′.

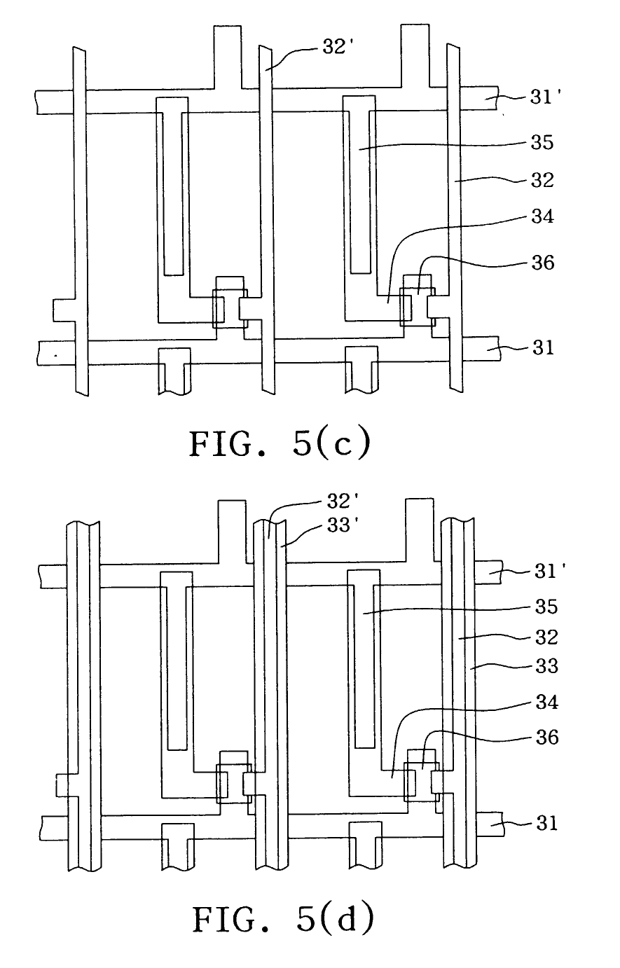

Now, a method for manufacturing the aforementioned IPS LCD is described with reference to FIGS. 5(a) to 5(d). As shown in FIG. 5(a), a metal material such as chromium is deposited and patterned to form the gate bus lines 31 and 31′ arranged in the transverse direction and the gate electrode 35 extended from the gate bus line 31′ arranged in the longitudinal direction on a transparent substrate.

As shown in FIG. 5(b), a silicon nitride layer, an amorphous silicon layer and an n+ amorphous silicon layer are deposited, and the upper two layers are patterned to form the switching elements 36 consisting of the amorphous silicon layer and n+ amorphous silicon layer at the cross points of the gate bus lines 31 and 31′ and the pixel electrodes 34(as shown in FIG. 3(a)).

Then, a conductive material is deposited and patterned to form the signal bus lines 32 and 32′ arranged in the longitudinal direction and the pixel electrodes 34 overlapping with the gate electrode 35 and connected to the switching elements 36(as shown in FIG. 5(c)). A silicon nitride layer and a resin layer with a thickness of 3-5 μm are deposited in sequence on the whole surface including the surface of the signal bus lines 32, the signal bus lines 32′ and the pixel electrodes 34. As shown in FIG. 5(d), a transparent conductive material such as ITO (indium-tin-oxide) is deposited and patterned to form the common electrodes 33 and 33′ respectively overlapping with the signal bus lines 32 and 32′.

FIG. 3(b) shows a cross-sectional diagram taken along the line 4-4 of FIG. 3(a). First of all, the gate electrode 35 as well as the gate bus lines 31 and 31′ are formed on a glass substrate 37, and a gate-insulating layer 381 is overlaid thereon. Secondly, the pixel electrode 34 and the signal lines 32 and 32′ are separately formed on the gate-insulating layer 381 in perpendicular to the gate bus lines 31, and a passive layer 382 is overlaid thereon. Finally, a resin layer 383 with a thickness of 3-5 μm is overlaid on the passive layer 382, and the common electrodes 33 and 33′ separately overlapping with the signal bus lines 32 and 32′ are formed on the resin layer 383. The common electrodes 33 and 33′ are made of a transparent conductive material such as ITO, and the pixel electrode 34 and the gate bus lines 31 and 31′ are made of a metallic material. A storage capacitor C of the pixel 30 formed between the gate electrode 35 and the pixel electrode 34 has a storage capacitance to induce a horizontal electric field to control the arrangement direction of the liquid crystal.

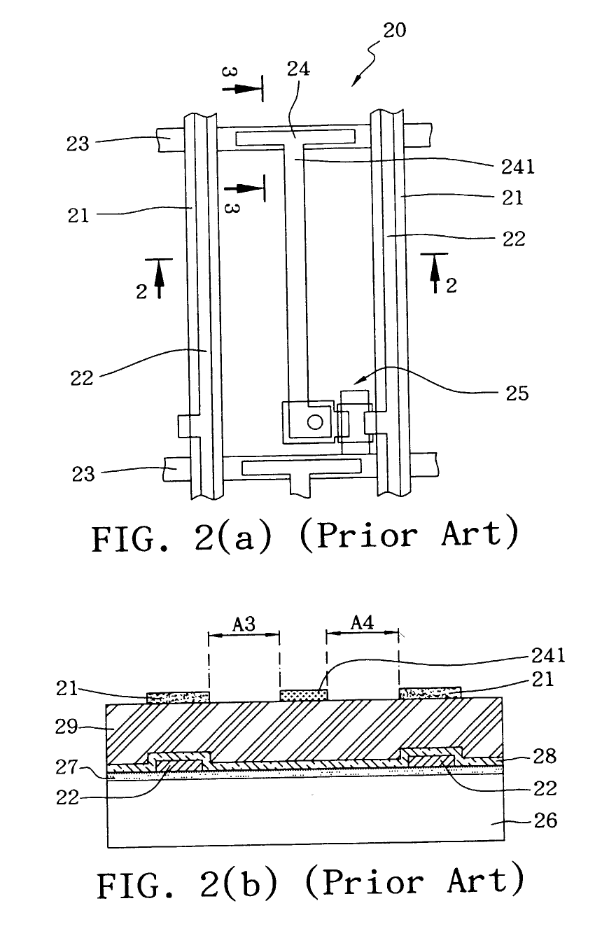

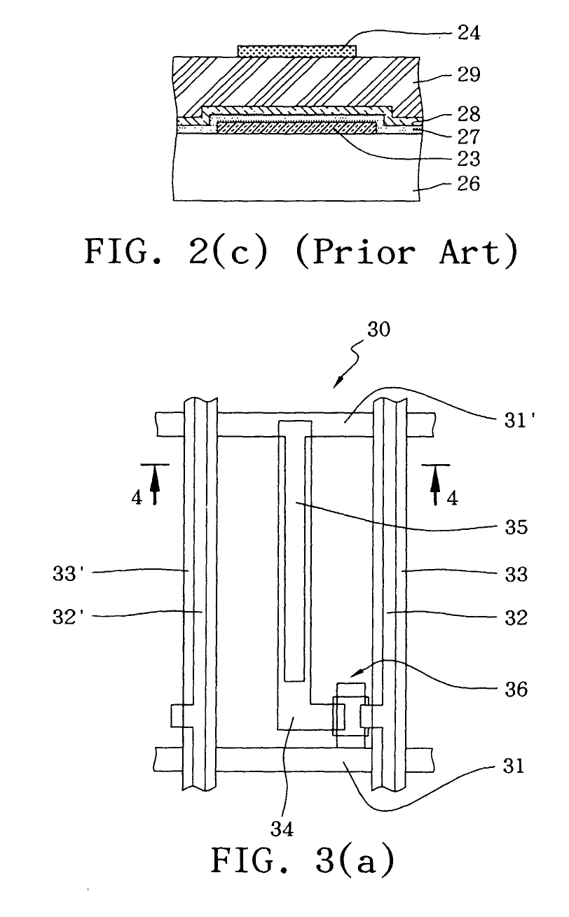

In comparison with FIG. 2(a), the width of the gate bus line 31′ of the pixel 30 in FIG. 3(a) is narrower than the gate bus line 23 of the pixel 20 in FIG. 2(a). In the other hand, the gate electrode 35 and the pixel electrode 31 also can provide a sufficient storage capacitance therein the same as the pixel 20 provides. In conclusion, the present invention is to improve the transmittance of light on an IPS LCD by reducing the width of gate bus line to obtain a high aperture ratio.

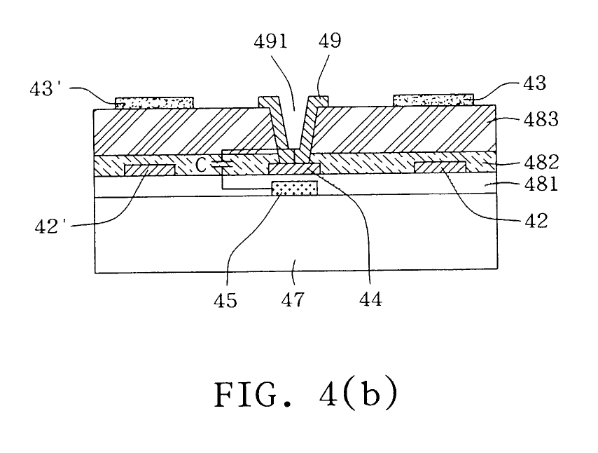

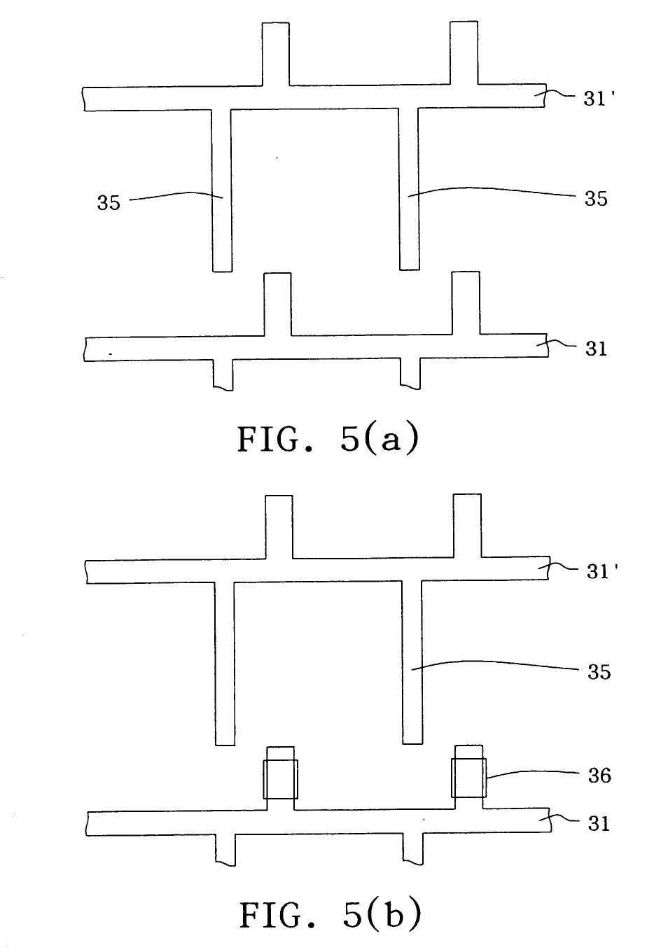

According to a further aspect, the disposition of liquid crystal is controlled by a horizontal electric field formed by the common electrode and the pixel electrode, and the horizontal electric field becomes weak if the thickness of the resin layer 383 is too thick. The second embodiment of the present invention, as shown in FIG. 4(a), provides an improved structure to increase the horizontal electric field, so it is not necessary to apply a high voltage power for an IPS LCD to display.

FIG. 4(a) shows a schematic layout diagram of the IPS LCD in accordance with the second embodiment of the present invention. A pair of gate bus lines 41 and 41′ is formed on a transparent insulating substrate such as a glass substrate in a transverse direction, and the gate electrode 45 extended from the gate bus lines 41′ of the adjacent pixel goes towards the gate bus lines 41. A first pixel electrode 44 completely overlaps with the gate electrode 45 from the middle of the gate bus lines 41′ to the position close to gate bus lines 41, and is wider than the gate electrode 45. The signal bus lines 42 and 42′ separately cross the gate bus lines 41 and 41′ on two longitudinal sides of the pixel 40 in transverse direction. A switching element 46 formed in the pixel 40 is a three-terminal thin film transistor whose one terminal is connected to the first pixel electrode 44 and the other two terminals are separately connected to the gate bus line 41 and the signal bus line 42. One common electrode 43 overlaps with the signal bus line 42, and another common electrode 43′ overlaps with the signal bus line 42′. In addition, a second pixel electrode 49 overlaps with the first pixel electrode 44, and is in contact with the first pixel electrode 44 through contact holes 491. Moreover, the second pixel electrode 49 is wider than the first pixel electrode 44 and the gate electrode 45.

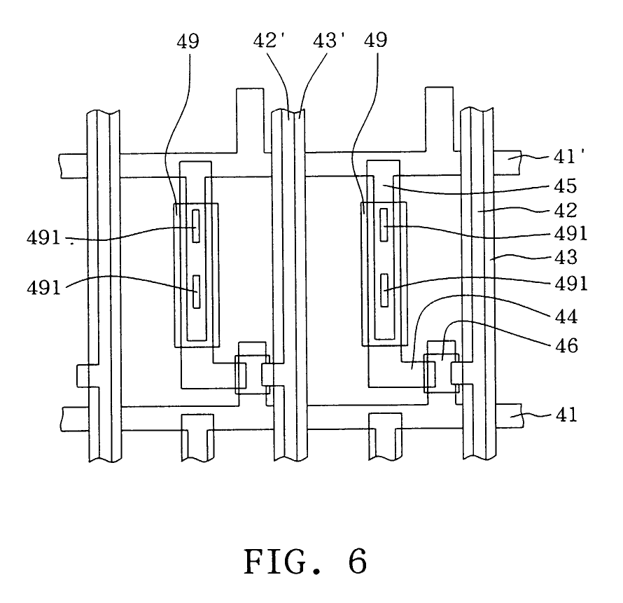

A method for manufacturing the IPS LCD according to the second embodiment (as shown in FIG. 4(a)) is similar to the first embodiment according to the manufacturing steps from FIG. 5(a) to FIG. 5(d), and further comprises a step to form the second pixel electrodes 49, as shown in FIG. 6. After the common electrodes 43 and 43′ formed, the resin layer is etched to form the contact holes 491, and a transparent conductive material such as ITO is deposited and patterned to form the second pixel electrodes 49 respectively overlapping with and contacting the first pixel electrodes 45 through contact holes 491.

FIG. 4(b) is a cross-sectional diagram taken along the line 5-5 of FIG. 4(a). First of all, the gate electrode 45 and the gate bus lines 41 and 41′ are formed on a glass substrate 47, and a gate-insulating layer 481 is overlaid thereon. Secondly, the first pixel electrode 44 and the signal lines 42 and 42′ are separately formed on the gate-insulating layer 481 in perpendicular to the gate bus lines 41, and a passive layer 482 is overlaid thereon. Finally, a resin layer 483 with a thickness of 3-5 μm is overlaid on the passive layer 482, and the common electrodes 43 and 43′ separately overlapping with the signal bus lines 42 and 42′ are formed on the resin layer 483. The contact holes 491 are through holes of the resin layer 483 and the passive layer 482 for the second pixel electrode 49 overlaid on the upper surface to contact the first pixel electrode 44 acted as an intermediate layer. The common electrodes 43 and 43′ and the second pixel electrode 49 are made of a transparent conductive material such as ITO (indium-tin-oxide), and the first pixel electrode 44 and the gate bus lines 41 and 41′ are made of a metal material. A storage capacitor Cₛₜ of the pixel 40 formed between the gate electrode 45 and the pixel electrode 44 has a storage capacitance for inducing a horizontal electric field to control the arrangement direction of the liquid crystal.

In comparison with FIG. 3(a), the width of the gate bus lines 41′ of the pixel 40 in FIG. 4(a) is the same as that of the gate bus lines 31 of the pixel 30. Furthermore, the pixel 40 can provide a stronger horizontal electric field by employing the second pixel electrode 49. Hence, the second embodiment has lower power consumption due to increasing horizontal electric fields by means of an additional ITO electrode overlaid and contacting the pixel electrode to enhance the storage capacitance.

The above-described embodiments of the present invention are intended to be illustrative only. Numerous alternative embodiments may be devised by persons skilled in the art without departing from the scope of the following claims.

What is claimed is:

1. An in-plane switching liquid crystal display with high aperture ratio, comprising:
a transparent insulating substrate;
a plurality of gate bus lines formed on the transparent insulating substrate;
a first insulating layer overlaid on the gate bus lines and the transparent insulating substrate;
a plurality of signal bus lines disposed on the first insulating layer;
a plurality of unit, pixel regions, each of the unit pixel regions defined by a pair of the gate bus lines and a pair of the signal bus lines;
a plurality of gate electrodes extended from the gate bus lines and formed in the unit pixel region;
a plurality of first pixel electrodes formed on the first insulating layer, each of the first pixel electrodes overlapping with the gate electrode in the unit pixel region;
a plurality of switching elements separately formed in each unit pixel region, each of the switching elements connected to the first pixel electrode, the gate bus line and the signal bus line;
a second insulating layer overlaid on the signal bus lines, the first pixel electrodes and the transparent insulating substrate;
a third insulating layer overlaid on the second insulating layer; and
a plurality of common electrodes formed on the third insulating layer, each of the common electrodes overlapping with the signal bus line.

2. The in-plane switching liquid crystal display of claim 1, further comprising a plurality of second pixel electrodes formed on the third insulating layer, wherein each of the second pixel electrodes contacts the first pixel electrode through at least one contact hole in the second insulating layer and the third insulating layer.

3. The in-plane switching liquid crystal display of claim 1, wherein the common electrodes are made of indium tin oxide.

4. The in-plane switching liquid crystal display of claim 1, wherein the switching elements are thin film transistors.

5. The in-plane switching liquid crystal display of claim 1, wherein the transparent insulating substrate is a glass substrate.

6. The in-plane switching liquid crystal display of claim 2, wherein the second pixel electrodes are made of indium tin oxide.

7. The in-plane switching liquid crystal display of claim 1, wherein the third insulating layer is about 3-5 μm in thickness.

8. The in-plane switching liquid crystal display of claim 1, wherein the first pixel electrode is wider than the gate electrode.

9. The in-plane switching liquid crystal display of claim 2, wherein the second pixel electrode is wider than the gate electrode and the first pixel electrode.

10. An in-plane switching liquid crystal display with high aperture ratio, comprising:
a transparent insulating substrate;
a plurality of gate bus lines formed on the transparent insulating substrate;
a plurality of signal bus lines disposed on the transparent insulating substrate;
a plurality of unit pixel regions, each of the unit pixel regions defined by a pair of the gate bus lines and a pair of the signal bus lines;
a plurality of gate electrodes extended from the gate bus lines and formed in the unit pixel region;
a plurality of first pixel electrodes, each of the first pixel electrodes overlapping with the gate electrode in the unit pixel region;
a plurality of switching elements separately formed in each unit pixel region, each of the switching elements connected to the first pixel electrode, the gate bus line and the signal bus line; and
a plurality of common electrodes, each of the common electrodes overlapping with the signal bus line.

11. The in-plane switching liquid crystal display of claim 10, further comprising a first insulating layer interposed between the gate bus lines and the signal bus lines.

12. The in-plane switching liquid crystal display of claim 10, further comprising a second insulating layer and a third insulating layer interposed between the signal bus lines and the common electrodes and between the first pixel electrodes and the common electrodes.

13. The in-plane switching liquid crystal display of claim 12, further comprising a plurality of second pixel electrodes formed on the third insulating layer, wherein each of the second pixel electrodes contacts the first pixel electrode through at least one contact hole in the second insulating layer and the third insulating layer.

14. The in-plane switching liquid crystal display of claim 10, wherein the common electrodes are made of indium tin oxide.

15. The in-plane switching liquid crystal display of claim 10, wherein the switching elements are thin film transistors.

16. The in-plane switching liquid crystal display of claim 10, wherein the transparent insulating substrate is a glass substrate.

17. The in-plane switching liquid crystal display of claim 13, wherein the second pixel electrodes are made of indium tin oxide.

18. The in-plane switching liquid crystal display of claim 12, wherein the third insulating layer is about 3-5 μm in thickness.

19. The in-plane switching liquid crystal display of claim 10, wherein the first pixel electrode is wider than the gate electrode.

20. The in-plane switching liquid crystal display of claim 13, wherein the second pixel electrode is wider than the gate electrode and the first pixel electrode.
